(19) United States
(12) Patent Application Publication
(10) Pub. No.: US 2004/0199618 A1
(43) Pub. Date: Oct. 7, 2004

(54) Data replication solution

(76) Inventors: Gregory John Knight, Brooklyn Park, MN (US); Brian Derek Davies, Maple Grove, MN (US); Kent S. Christensen, Shorewood, MN (US)

Correspondence Address: Beck & Tysver, P.L.L.C., Suite 100, 2900 Thomas Avenue S., Minneapolis, MN, 55416, US

(21) Appl. No.: 10/359,841

(22) Filed: Feb. 6, 2003

(51) Int. Cl. G06F 15/173

(52) U.S. Cl. 709/223

(57) ABSTRACT

The disclosure is directed to a data replication policy engine for use with a storage network. The storage network includes a first storage network, a second storage network and a wide area network. The data replication policy engine includes a monitor and analyze aspect and a corrective action aspect. The monitor and analyze aspect is adapted to be operably coupled to at least a subset of components selected from the storage network. The monitor and analyze aspect is also adapted to monitor the status of the selected components and the storage network while the storage network is operating. Still further, the monitor and analyze aspect is adapted to describe problems discovered in the selected components and the storage network. The corrective action aspect is operably coupled to the monitor and analyze aspect and to at least the subset of components selected from a first storage area network, the second storage area network and the wide area network. The corrective action aspect automatically receives the described problems from the monitor and analyze aspect and automatically takes corrective action to resolve at least some of the problems discovered by the monitor and analyze aspect.

### BACKGROUND

The present disclosure relates to computer networks. More specifically, the present disclosure relates to a data replication solution. In one example, the data replication solution uses policy-based automation to manage a complete data replication solution.

Many users of computer generated information or data often store the information or data locally and also replicate the data at remote facilities. These remote facilities can be on multiple sites, perhaps even around the world, to ensure the data will be available in case one or some of the facilities fail. For example, a bank may store information about a person's savings account on a local computer storage device and may replicate the data on remote storage devices around the country or around the world. Thus, information regarding the savings account and access to the funds in the savings account is available even if one or some of these storage devices were to fail for whatever reason.

In general, computer data is generated at a production site and can also be stored at the production site. The production site is one form of storage area network. The production site is linked over a wide area network, such as the Internet or a dedicated link, to one or more remote alternate sites. Replicated data is stored at the alternate sites. The alternate site is another form of storage area network. Often, a storage area network can be a hybrid where it functions to generate and store local data as well as replicate data from another storage area network. Many storage area networks can be linked over the wide area network. In the example above, one storage area network could be at a bank office. The storage area network is connected over a wide area network to remote locations that replicate the data. These locations can include other bank offices or a dedicated storage facility located hundreds of miles away.

The computer network is operating smoothly if certain service level criteria are met. The described computer networks include hundreds of components including hardware and software components that may be scattered throughout the world. If one or more components fail and at least some of the service level criteria are not met, data stored on the network may be unavailable, performance may be affected, and other adverse symptoms can occur. Research has demonstrated that a user of the computer network, such as the bank, will take fifty-four minutes to report a critical failure to a network administrator. During this time, the computer network has not been operating properly and the benefits of storing information at multiple locations has been reduced or lost.

A number of solutions are available to prevent certain types of local problems from occurring, before they arise. However, none of these solutions address the issues that arise in linking multiple sites over the wide area, and none provide a complete automated solution, addressing the specific problems encountered moving data from a production site, over wide-area equipment, to a remote site.

For example, one popular solution, which operates on a single site basis, focuses on the specific issue of storage provisioning. The broader issue of tying multiple sites together, and handling data between them across a wide-area, is ignored. This solution monitors the local storage to determine if storage usage has exceeded a threshold percentage, such as 80%, of maximum storage capacity. If the threshold has been exceeded, the solution makes additional storage available so that capacity is now greater than before. This solution is suited for handling problems that develop between the server and the storage array in a local storage area network, and is not suited for handling problems that develop at other storage area network facilities or along the connections between the storage area networks.

### SUMMARY

The present disclosure is directed to a data replication policy and policy engine that applies policy-based automation in a local or remote data replication scenario. The policy monitors the data replication solution over the entire multi-site storage network, and can take into consideration multiple protocols such as Fibre Channel and Internet Protocol. The policy also takes automatic corrective actions if problems develop anywhere in the replication solution. As opposed to prior art solutions that concern themselves with server to storage issues within a storage area network, the present disclosure deals with storage to storage issues over the entire storage network.

In one form, the disclosure is directed to a data replication policy engine for use with a storage network. The storage network includes a first storage network, a second storage network and a wide area network. The data replication policy engine includes a monitor and analyze aspect and a corrective action aspect.

The monitor and analyze aspect is adapted to be operably coupled to at least a subset of components selected from the storage network. The monitor and analyze aspect is also adapted to monitor the status of the selected components and the storage network while the storage network is operating. Still further, the monitor and analyze aspect is adapted to describe problems discovered in the selected components and the storage network.

The corrective action aspect is operably coupled to the monitor and analyze aspect and to at least the subset of components selected from a first storage area network, the second storage area network and the wide area network. The corrective action aspect automatically receives the described problems from the monitor and analyze aspect and automatically takes corrective action to resolve at least some of the problems discovered by the monitor and analyze aspect.

In another form, the disclosure is directed to a computerized method for identifying and correcting at least some problems in a storage network. The storage network includes a set of components in two or more storage area networks linked together by a wide area network. The computerized method includes monitoring the set of components for a problem and correcting the problem. Correcting the problem includes applying a set of rules to the problem to select a network action, and applying the selected network action to the storage network.

In still another form, the disclosure is directed to an appliance for use with a storage network. The appliance includes a storage router, a storage services server, and a management server. The storage services server is operably coupled to the storage router, and the storage services server is adapted to be operably coupled to components of a storage network. The storage services server is adapted to move data between the components of the storage network. The management server is operably coupled to the storage router, and the management server is adapted to be operably coupled to the components. The management server is adapted to run a data replication policy engine that includes a monitor and analyze aspect and a corrective action aspect.

### BRIEF DESCRIPTION OF THE FIGURES

FIG. 1 is a schematic view of an environment of the present disclosure.

FIG. 2 is a schematic view of an appliance of the present disclosure suitable for use in the environment shown in FIG. 1.

FIG. 3 is a schematic view of the appliance of FIG. 2 incorporated into the environment of FIG. 1.

FIG. 4 is a block diagram of one example of a policy engine of the present disclosure operating in the environment shown in FIG. 1.

FIG. 5 is a block diagram of another example of a policy engine of the present disclosure operating in the environment shown in FIG. 1.

FIG. 6 is a more detailed block diagram of an example of a policy engine operating in the environment of FIG. 1.

FIG. 7 is a schematic view of a simplified version of the environment of FIG. 1.

### DESCRIPTION

This disclosure relates to remote data replication solutions. The disclosure, including the figures, describes the data replication solution with reference to several illustrative examples. Other examples are contemplated and are mentioned below or are otherwise imaginable to someone skilled in the art. The scope of the invention is not limited to the few examples, i.e., the described embodiments of the invention. Rather, the scope of the invention is defined by reference to the appended claims. Changes can be made to the examples, including alternative designs not disclosed, and still be within the scope of the claims.

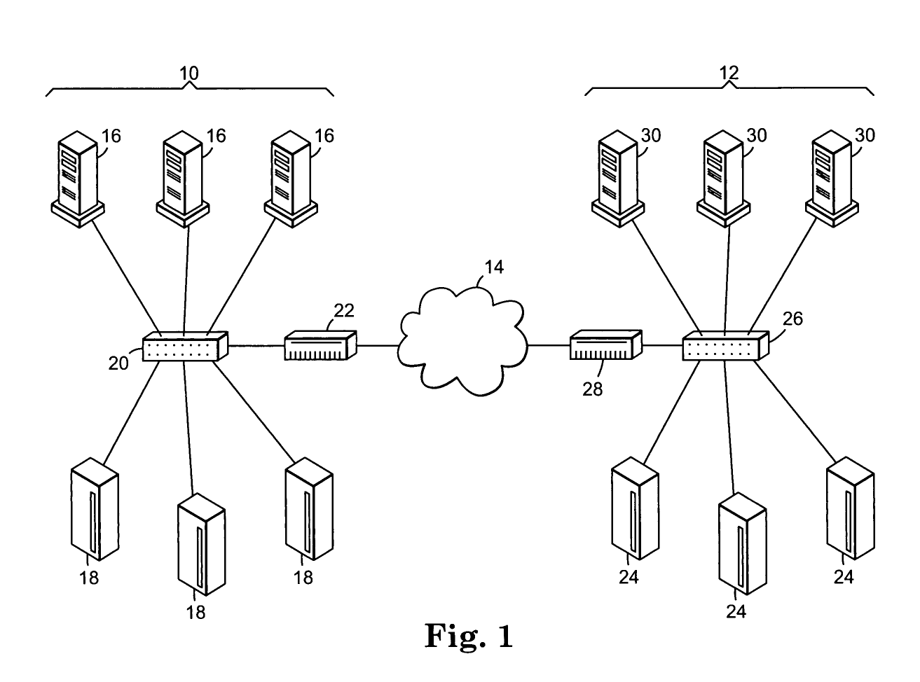

FIG. 1 is a schematic view of an environment of the present disclosure. FIG. 1 shows two storage area networks 10, 12 connected together via a wide area network 14. Although only two storage area networks are shown in the figure, the environment can include more than two storage area networks connected over a wide area network, or the like. The storage area networks can be connected via the wide area network using a broad range of network interfaces including IP, ATM, T1/E1, T3/E3, and others. The plurality of storage area networks, and the at least one wide area network are included in a “storage network.”

Storage area network 10 typically includes at least one, but typically a plurality of servers 16 connected to at least one but typically a plurality of storage devices 18 through one or more switches 20. The switch 20 is connected to a storage router 22 that interfaces with the wide area network 14. Storage area network 10 in this example is often referred to as a production site.

Storage area network 12 typically includes at least one but typically a plurality of storage devices 24 connected to one or more switches 26. The switch is connected to a storage router 28 that interfaces with the wide area network 14. Storage area network 12 in this example is often referred to as an alternate site. Accordingly, the production site and alternate site are operably coupled together over the wide area network 14. The alternate site can also be a fully active production site in its own right. Storage area network 12 also typically includes one or more servers 30 coupled to the switch 26.

The components of each storage area network 10, 12 can be connected together by any suitable interconnect. The preferred interconnect for present day storage area networking (SAN) is Fibre Channel. Fibre Channel is a reliable one and two gigabit interconnect technology that allows concurrent communications among workstations, mainframes, servers, data storage systems, etc. Fibre Channel provides interconnect systems for multiple topologies that can scale a total system bandwidth on the order of a terabit per second. In this case, switches 20, 26 are Fibre Channel switches.

Interconnect technologies other than Fibre Channel can be used. For example, another interconnect for SAN is a form of SCSI over Internet Protocol called iSCSI. In this case, switches 20, 26 are iSCSI switches and storage routers 22, 28 are compression boxes. Other interconnect technologies are contemplated. In general, the SAN is not limited to just Fibre Channel storage (or iSCSI storage). A SAN can include storage in general, such as using any protocol or any infrastructure.

Storage area networks 10, 12 could be components of larger local networks. For example, switches 20, 26 could be connected to directors or the like that are connected to mainframes, personal computers, other storage devices, printers, controllers and servers, over various protocols such as SCSI, ESCON, Infiniband, and others. For simplicity, the present disclosure is directed to storage area networks connected over a wide area network.

Information, or data, is created or modified at the production site, i.e., storage area network 10, at servers 16 and stored in the storage devices 18. The data is then passed across the wide area network 14 and replicated on storage devices 24 at the alternate site, i.e., storage area network 12. The data now exists in two (at least two) separate storage area networks that can be located a long way away from each other. A suitable back up is provided in case one storage area network should fail or data at one location becomes corrupted.

In one example, the production site performs the functions of generating information and storing the generated at the production site, while the alternate site only performs the function of storing information generated at the production site. In another example, both the production site and the alternate site generate and store their own data, while at the same time storing data generated at the other site. Other combinations exists, such as the alternate site generating data but not storing it on the production site, or one site taking over generating data or storing data after a period of time. Still, others are possible.

The data replication policy engine of the present disclosure is adapted to run in this environment. In one example, the data replication policy engine resides as software within one or more of the components of the storage network. In another example, the data replication policy engine can reside on a unique component added to the storage network for the sole purpose of running the policy engine. In still another example, the policy engine can be run from a location remote from the storage network, such as the office of the network administrator, and be connected to the storage network over a link to the wide area network 14. Other examples or combinations of examples are contemplated. One particularly noteworthy example, however, is an appliance, described below.

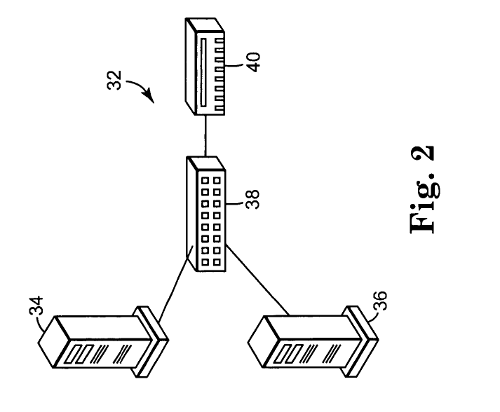

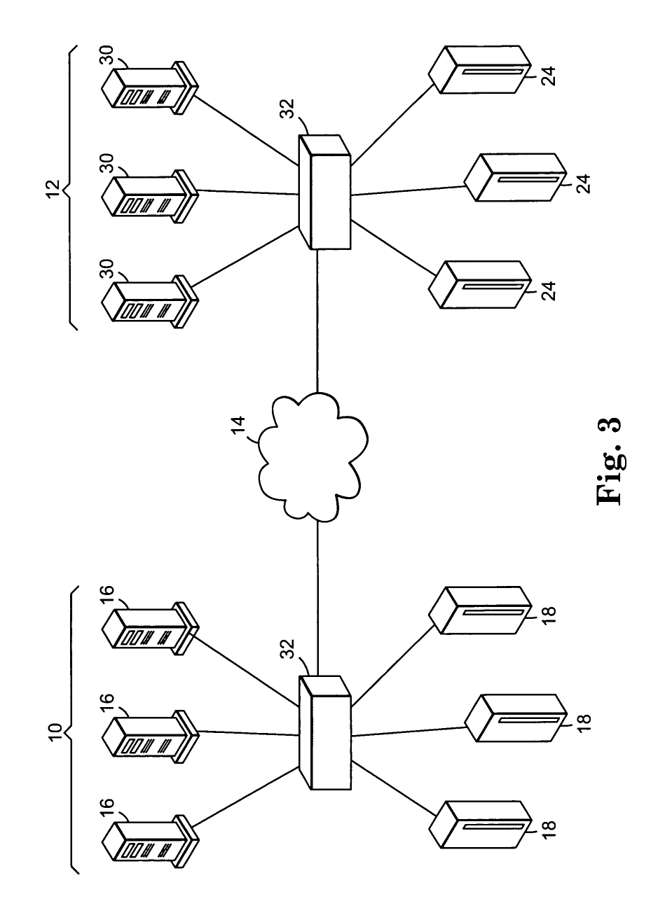

FIG. 2 is a schematic view of an appliance 32, and FIG. 3 is a schematic view of the appliances 32 incorporated into the storage network of FIG. 1. The appliance 32, which includes the functions of data transfer and data management, is shown schematically as including a pair of servers 34, 36, a Fibre Channel switch 38 and a storage router 40 connected together with Fibre Channel technology. The appliance 32 is shown incorporated into a production site 10 and an alternate site 12. Other components of the storage area networks 10, 12 are connected to the appliance 32, and the appliance interfaces with the wide area storage network. Alternate forms of the appliance are possible, such as all components could be provided within a single housing, or otherwise. The form of the appliance is immaterial, and FIG. 2 is illustrative more of the tasks of appliance rather than to a specific structure of the appliance. Switch 38 generally performs the same functions as switches 20, 26, and storage router 40 generally performs the same functions as storage routers 22, 28. Server 34 is referred to as a storage services server. It performs the task of moving data to and from the appliance, i.e., between appliances, very quickly. Server 36 is referred to as a management server. It performs the task of running the data replication policy engine described below.

FIG. 4 is a block diagram of an example of a data replication policy engine 42 operating on the storage network of FIGS. 1 and 3. The storage network includes a first storage area network (SAN A) 10 and a second storage area network (SAN B) 12 connected over the wide area network (WAN) 14. The data replication policy engine 42 can operate on all aspects of the storage network, i.e., SANs 10, 12 and WAN 14 (and any other SANs). Often the storage network will contain hundreds of components, or more, and a customer might not find it necessary to operate the policy engine 42 on all components. Accordingly, the customer can select a subset of components within the storage network that are applied to the policy engine 42.

The policy engine includes two major aspects. The first major aspect monitors and analyzes 44 the storage network or a subset of the storage network. The second major aspect takes corrective action 46 based on the monitoring and analyzing of the network 44. These aspects are performed while data is moving between the SAN A 10, WAN 14 and SAN B 12 in one or both directions.

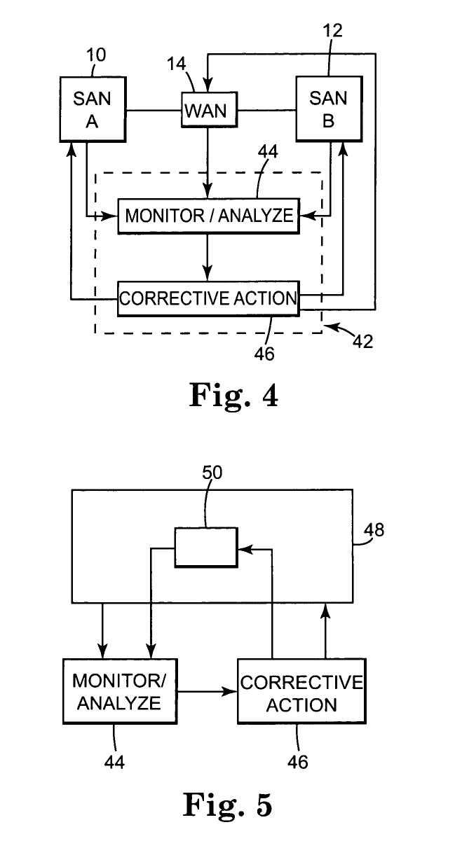

FIG. 5 is another block diagram depiction of the example of FIG. 4. The figure depicts the data replication policy engine including the monitor/analyze aspect 44 and corrective action aspect 46. Block 48 depicts the storage network, including SAN A 10, SAN B 12, and WAN 14 (and any other SANs). Block 50 depicts a selected component within the storage network. If the policy engine operates on a subset of all the components in the storage network, component 50 is a selected component within the subset. FIG. 5 shows an example where the policy engine operates on the overall network 48, or a subset of the network, and the individual components on the network 50, or the components within the subset of the network, or another set of selected components.

The monitor and analyze aspect 44 of the data replication solution 42 can perform several functions in the examples. In one example, a customer or the network administrator can establish at least one, but typically many, thresholds called Service Level Criteria. In this example, the aspect 44 monitors the solution to ensure the Service Level Criteria are met. In another version, the aspect 44 compares the current quality of the wide area link to user-defined policy values, and notes changes. In another example, the aspect 44 monitors the quality of the wide area link. In still other examples, the aspect monitors configuration changes of the components 50. These changes can include cabling changes, microcode updates, hardware substitutions, or the like. Other examples are now known to those skilled in the art.

In addition to monitoring, aspect 44 can also perform the function of analyzing what was monitored. In one example, aspect 44 also provides a high level description of any problem or problems detected. Once the problem is detected and described, the data replication solution is able to take corrective action 46.

The corrective action aspect 46 automatically takes corrective action when problems develop according to selected policy rules to maintain the correct operation of the data replication solution. For example, the aspect 46 applies policy-based automation in both a local and a remote data replication scenario. Corrective action is automatic. In addition, corrective action can include applying policy and traffic priority across a multi-protocol solution.

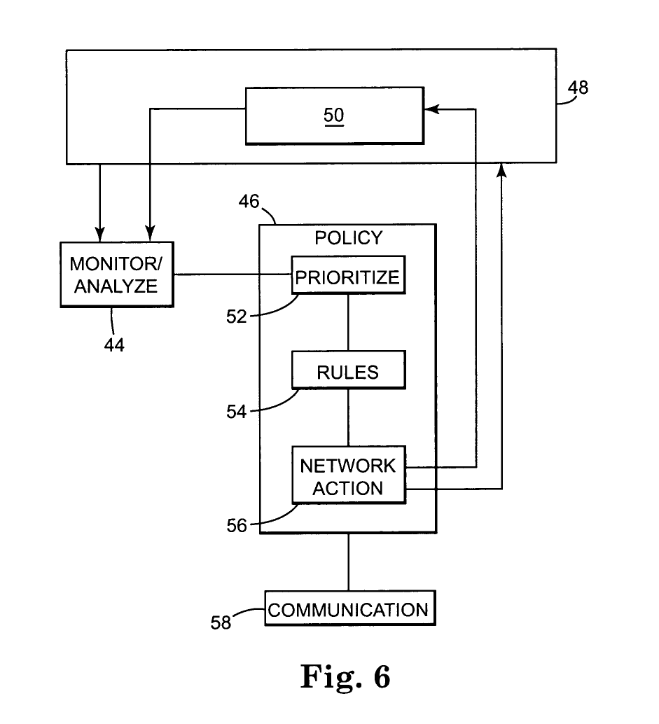

FIG. 6 is a more detailed block diagram of the examples of the data replication solution 42 shown in FIGS. 4 and 5. The solution monitors and analyzes 44 the storage network and components defined in the data replication solution while data is moved about the network. In one example, if a problem arises with a component, the solution determines whether the component is protected by the policy. If a problem is detected, that problem is described in high level terms and passed to the corrective action aspect 46, which includes the policy. This includes prioritization 52, application of policy rules 54, and the taking of network actions 56. Warnings, alerts, and logs can be created in a communication aspect 58.

Monitoring is done over multiple protocols. In other words, monitoring is performed over both the SAN protocol, or protocols, such as Fibre Channel, and over the wide area network, such as IP protocol. For example, if there is an error related to an IP protocol, corrective action can be taken from a Fibre Channel component. Accordingly, the solution can include a multiprotocol aspect (not shown), with which problems and issues across different protocols and environments (such as Fibre Channel, Internet Protocol, etc.) can be assessed as a whole (each taking regard for the other). The multiprotocol aspect also allows corrective actions to be taken in one or more of those protocol environments, to address the problems & issues seen, not necessarily in the same protocol environment. In the described example, the multiple protocol aspect is included in the monitor and analyze aspect 44 and the corrective action aspect 46.

Policy based logic is used to prioritize a problem, and this permits that the same kind of problem can be handled differently in different applications. In the example shown, the corrective action aspect includes an application-centric traffic prioritization aspect 52. With this aspect 52 traffic from one application, which has been deemed a high priority application by the policies, can be given priority over traffic from a lower priority application. For example, applications can be categorized into different priority groups. A database replication application can require a priority one category because its requirements are far more stringent than those of a mail application, which may only receive a priority two category. Accordingly, problems with the database replication application would be corrected prior to the mail application. Similarly, policy based management would not allow corrective action to a priority two application to request so many resources that it would adversely impact a priority one application. For example, a scheduled backup, categorized as priority two, that needs to resynchronize may request large to unlimited bandwidth, starving a production synchronous application, categorized as a priority one, that has a direct impact on the production servers 16. Accordingly, corrective action for a describe problem affecting a lower priority application is at least one of delayed and altered if the corrective action would adversely affect the performance of an operating higher priority application.

Prioritization can be effective over the SAN (e.g. Fibre Channel) and the wide area network. Accordingly, in one example, the aspect can prioritize data from the application, over Fibre Channel, through Fibre Channel to IP equipment, over the wide area network, through the IP to Fibre Channel equipment, over the remote Fibre Channel, and to the destination storage media (such as disk drives).

The policy 46 also applies a set of rules 54 to determine appropriate corrective actions to the detected and described problems. In one example, the rules can include labels that correspond with the high level descriptions of the problems. The labels then correspond with actions to be taken to address the described problem. In one version, the policy rules are very much like a look-up table, the actions corresponding to the description of the problems can be predetermined. In another version, the corresponding actions can become more intelligent. The corresponding actions can be automatically updated if problems reoccur and previous corresponding actions are determined not to work as efficiently others.

Thus, the rules 54 can include intelligence, rather than merely a correspondence between selected problems and predetermined solutions. The policy 46 applies the intelligence to the high level problem, and not necessarily just the specific singular problem reported or described, understanding the reported problems at a higher level than just those reported problems, and taking a more global action than just acting on the specific problems reported.

Once the corresponding actions are determined from the rules 54, the policy is able to take network actions 56 to correct the problems. In some examples, network actions can include trigger failovers such as bypassing failed components, selecting different ports, or reconfiguring network traffic. In other examples network actions can include launching diagnostic tools to determine the characteristics and location of the problem. Certain problems may not be fixable by network actions alone, and will require the assistance of a technician either working alone or in combination with the data replication policy engine.

The data replication solution also alerts users to problems and prepares logs of actions in its communication aspect 58. Certain problems can require alerts to be broadcast to a customer or network administrator. Problems such as device status changes or storage area network configuration changes can trigger e-mail alerts or pager alerts, among other alerts. Other problems that do not require the immediate attention of the customer are merely logged and can later be retrieved by the customer or the network administrator. Examples are contemplated where no alerts or logs are provided.

Examples of a data replication policy are described below. In the first example, the data replication policy is triggered by a device status change. Specifically, a power supply has just failed in a component protected by the policy. One step in the process is to determine the criticality of the change based on the component's role in the network. Network actions can include a note of the change in the log, sending alerts via e-mails and pagers. Also, if necessary, the policy can cause a failover.

In the second example, the data replication policy is triggered by a storage area network configuration change, such as a broken cable, or a component protected by the policy has received new microcode. Again, one step in the process is to determine the criticality of the change based on the role of the device in the network. Network actions can include a note of the change in the log, sending alerts via e-mails and pagers. Also, if necessary, the policy can cause a failover.

In the third example, the data replication policy is triggered because a time of day was reached. One step in the process is to compare the time of day to a schedule of events. For example, a backup program may need to run from 1:00 a.m. to 4:00 a.m. and require different network throughput. Network actions can include changing traffic characterization of the storage area network to allow for different use. This may involve activating different zone configurations, selecting different ToS/QoS for Internet Protocol ports, or selecting different priorities for Fibre Channel traffic over Fibre Channel switches.

In the fourth example, the data replication policy is triggered because a data replication data packet has arrived at the appliance. One step in the process is to determine whether the data packet belongs to a high priority or performance critical application such as a database or a lower priority application such as a mail server. Network actions can include assigning a suitable priority to the data packet for sending it across the storage network, including both Internet Protocol and Fibre Channel parts of the storage network.

In the fifth example, the data replication policy is triggered because the quality of the WAN link begins to degrade. One step in the process is to determine the criticality of the degradation. Comparing the degradation to policy thresholds can do this. Network actions can include sending warnings and critical alerts. Additional network actions can include activating different zones, according to the severity of the degradation, for failover. Still additionally, network actions can include launching diagnostic tools on the degrading line to determine the characteristics and location of the problem.

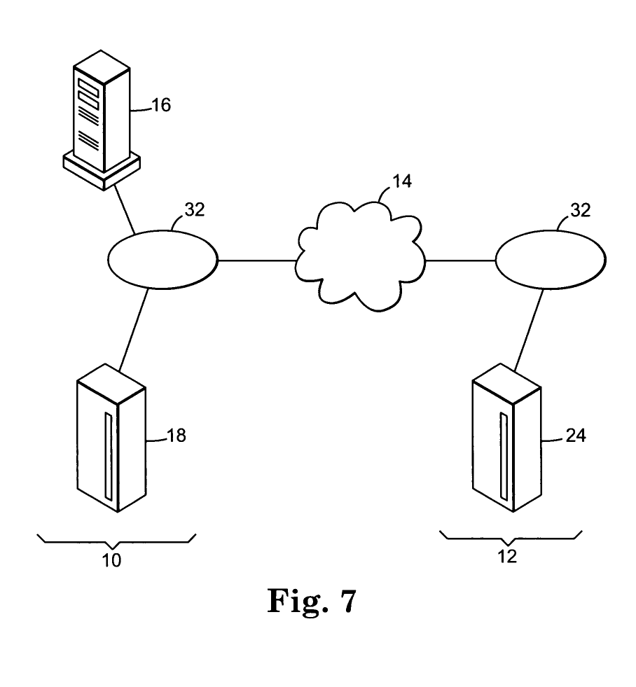

FIG. 7 is a simplified schematic view of the storage network of FIG. 3. FIG. 7 shows one server 16 at production site 10 connected to a storage device 18 through an appliance 32. The appliance is connected across a WAN 14 to an appliance 32 at the alternate site 12. The appliance 32 is connected to a storage device 24 at the alternate site 12. This figure is used to illustrate the high level operation of the data replication policy engine and how it is compared to prior art systems.

Prior art systems are suited to work in combination with the data replication policy engine on the storage network depicted in FIGS. 1, 3, and 7. Prior art system, like the one described above, work within a storage area network, and are concerned with issues that develop with server 16 to storage device 18 traffic. In other prior art systems, server 16 to storage 24 traffic issues can also be addressed through a process known as in-band virtualization. Accordingly, prior art systems concern themselves with vertical, i.e. server to storage connections and traffic.

The data replication policy of the present disclosure concerns itself with storage device 18 to storage device 24 connections and traffic. This can take place over multiple protocols and generates an entirely different set of issues than the prior art systems. Accordingly, starting and end points differ, trigger criteria differ, and actions taken differ from the prior art.

The present invention has now been described with reference to several embodiments. The foregoing detailed description and examples have been given for clarity of understanding only. Those skilled in the art will recognize that many changes can be made in the described embodiments without departing from the scope and spirit of the invention. Thus, the scope of the present invention should not be limited to the exact details and structures described herein, but rather by the appended claims and equivalents.

What is claimed is:

1. A data replication policy engine for use with a storage network, the data replication policy engine comprising:
a monitor and analyze aspect, the monitor and analyze aspect adapted to be operably coupled at least a subset of components selected from a first storage area network, a second storage area network and a wide area network,
wherein the monitor and analyze aspect is adapted to monitor the status of the selected components and the storage network while the storage network is operating and to describe problems discovered in the selected components and the storage network; and
a corrective action aspect operably coupled to the monitor and analyze aspect and to at least the subset of components selected from a first storage area network, the second storage area network and the wide area network,
wherein the corrective action aspect automatically receives the described problems from the monitor and analyze aspect and automatically takes corrective action to resolve at least some of the problems discovered by the monitor and analyze aspect.

2. The data replication policy engine of claim 1 and further comprising a multiprotocol aspect, wherein problems across different protocol environments are assessed as a whole and corrective actions are taken in at least one of the protocol environments.

3. The data replication policy engine of claim 1 wherein the corrective action aspect includes an application-centric traffic prioritization aspect wherein traffic from a high priority application is given priority over traffic from a lower priority application.

4. The data replication policy engine of claim 1 and further comprising a communication aspect operably coupled to the corrective action aspect, wherein the communication aspect is adapted to provide alerts and generate logs related to the described problems.

5. The data replication policy engine of claim 4 wherein the communication aspects provides alerts including e-mail alerts and pager alerts.

6. The data replication policy engine of claim 1 wherein the corrective action aspect prioritizes the described problems.

7 The data replication policy engine of claim 6 wherein the prioritization of the describe problem is at least one of:
wherein a described problem affecting a higher priority application is preferred over a described problem affecting a lower priority application, and
wherein corrective action for a describe problem affecting a lower priority application is at least one of delayed and altered if the corrective action would adversely affect the performance of an operating higher priority application.

8. The data replication policy engine of claim 1 wherein a set of rules is applied to the described problem to select a network action to correct the described problem.

9. A data replication policy engine for use with a storage network including components comprising a first storage area network, a second storage area network and a wide area network linking the first and second storage area networks, the data replication policy engine comprising:
a monitor and analyze aspect, the monitor and analyze aspect adapted to be operably coupled at least a subset of the components,
wherein the monitor and analyze aspect is adapted to monitor the status of the selected components and the storage network while the storage network is operating and to describe problems discovered in the selected components and the storage network; and
a corrective action aspect operably coupled to the monitor and analyze aspect and to at least the subset of components,
wherein the corrective action aspect automatically receives the described problems from the monitor and analyze aspect and automatically takes corrective action to resolve at least some of the problems discovered by the monitor and analyze aspect;
wherein the corrective action aspect includes a prioritization aspect operably coupled to the monitor and analyze aspect, rules operably coupled to the prioritization aspect, and network actions aspect operably coupled to the rules and to at least the subset of components.

10. The data replication policy engine of claim 9 wherein the prioritization aspect is an application-centric prioritization aspect.

11. The data replication policy engine of claim 9 wherein the rules include intelligence.

12. A computerized method for identifying and correcting at least some problems in a storage network, the storage network comprising a set of components in a plurality of storage area networks linked together by a wide area network, the method comprising:
monitoring the set of components for a problem;
correcting the problem, wherein correcting the problem includes,
applying a set of rules to the problem to select a network action; and
applying the selected network action to the storage network.

13. The computerized method of claim 12 wherein applying the set of rules includes applying intelligence.

14. The computerized method of claim 12 and further comprising communicating the problem.

15. The computerized method of claim 12, wherein correcting the problem further includes prioritizing the problem.

16. The computerized method of claim 12, and further comprising analyzing the problem to provide a description of the problem.

17. An appliance, comprising:
a storage router;
a storage services server operably coupled to the storage router, the storage services server adapted to be operably coupled to components of a storage network, wherein the storage services server is adapted to move data between the components of the storage network; and
a management server operably coupled to the storage router, the management server adapted to be operably coupled to the components,
wherein the management server is adapted to run a data replication policy engine comprising a monitor and analyze aspect and a corrective action aspect.

18. The appliance of claim 17, and further comprising a switch coupling the management server to the storage router and the storage services server to the storage router.

19. The appliance of claim 18 wherein the switch is a fibre channel switch.

20. The appliance of claim 17 wherein the appliance is contained within a single housing.
